(19) United States
(12) Patent Application Publication
(10) Pub. No.: US 2006/0140126 A1
(43) Pub. Date: Jun. 29, 2006

(54) Arbitrating virtual channel transmit queues in a switched fabric network

(75) Inventors: Tina C. Zhong, Chandler, AZ (US); James Mitchell, Chandler, AZ (US)

Correspondence Address: FISH & RICHARDSON, PC, P.O. BOX 1022, MINNEAPOLIS, MN, 55440-1022, US

(73) Assignee: Intel Corporation

(21) Appl. No.: 11/024,361

(22) Filed: Dec. 27, 2004

(51) Int. Cl. H04L 12/26; H04J 3/14; H04J 1/16; H04L 1/00

(52) U.S. Cl. 370/241

(57) ABSTRACT

A device in an AS fabric may include an event dispatch unit for generating event packets to be sent over the fabric to event handling agents. The AS device may arbitrate between different packets for the resources of a particular VC. The AS device may arbitrate between packets from different VCs downstream in the AS transaction layer while giving preference to high priority packets.

### BACKGROUND

PCI (Peripheral Component Interconnect) Express is a serialized I/O interconnect standard developed to meet the increasing bandwidth needs of the next generation of computer systems. PCI Express was designed to be fully compatible with the widely used PCI local bus standard. PCI is beginning to hit the limits of its capabilities, and while extensions to the PCI standard have been developed to support higher bandwidths and faster clock speeds, these extensions may be insufficient to meet the rapidly increasing bandwidth demands of PCs in the near future. With its high-speed and scalable serial architecture, PCI Express may be an attractive option for use with or as a possible replacement for PCI in computer systems. The PCI Express architecture is described in the PCI Express Base Architecture Specification, Revision 1.0a (Initial release Apr. 15, 2003), which is available through the PCI-SIG (PCI-Special Interest Group) (http://www.pcisig.com)].

Advanced Switching (AS) is an extension to the PCI Express architecture. AS utilizes a packet-based transaction layer protocol that operates over the PCI Express physical and data link layers. The AS architecture provides a number of features common to multi-host, peer-to-peer communication devices such as blade servers, clusters, storage arrays, telecom routers, and switches. These features include support for flexible topologies, packet routing, congestion management (e.g., credit-based flow control), fabric redundancy, and fail-over mechanisms. The AS architecture is described in the Advanced Switching Core Architecture Specification, Revision 1.0 (the “AS Specification”) (December 2003), which is available through the ASI-SIG (Advanced Switching Interconnect-SIG) (http//:www.asi-sig.org).

### BRIEF DESCRIPTION OF THE DRAWINGS

FIG. 1 is a block diagram of a switched fabric network according to an embodiment.

FIG. 2 shows the protocol stacks for the PCI Express and AS architectures.

FIG. 3 illustrates an AS transaction layer packet (TLP) format.

FIG. 4 illustrates an AS route header format.

FIG. 5 is a block diagram of an event dispatch unit.

FIG. 6 is a flowchart describing an event dispatch operation according to an embodiment.

FIG. 7 is a block diagram of a packet arbiter which controls access to the transmit resources of a particular virtual channel (VC).

FIG. 8 is a flowchart describing a packet arbitration operation according to an embodiment.

FIG. 9 shows states and transitions in an exemplary state machine for arbitrating between packets in a VC.

FIG. 10 is a block diagram of a circuit for identifying the packet type for the different AS protocol interfaces.

FIG. 11A is a flowchart describing state transitions in the state machine for requests for ordered-only packets.

FIG. 11B is a flowchart describing state transitions in the state machine for requests for bypass capable packets.

FIG. 12 is a block diagram of a packet arbiter in the AS transaction layer for arbitrating between packets from multiple VCs.

FIG. 13 is a flowchart describing a packet arbitration operation according to an embodiment.

### DETAILED DESCRIPTION

FIG. 1 shows a switched fabric network 100 according to an embodiment. The network may include switch elements 102 and end nodes 104. The switch elements 102 constitute internal nodes of the network 100 and provide interconnects with other switch elements 102 and end nodes 104. The end nodes 102 reside on the edge of the switch fabric and represent data ingress and egress points for the switch fabric. The end nodes may encapsulate and/or translate packets entering and exiting the switch fabric and may be viewed as “bridges” between the switch fabric and other interfaces.

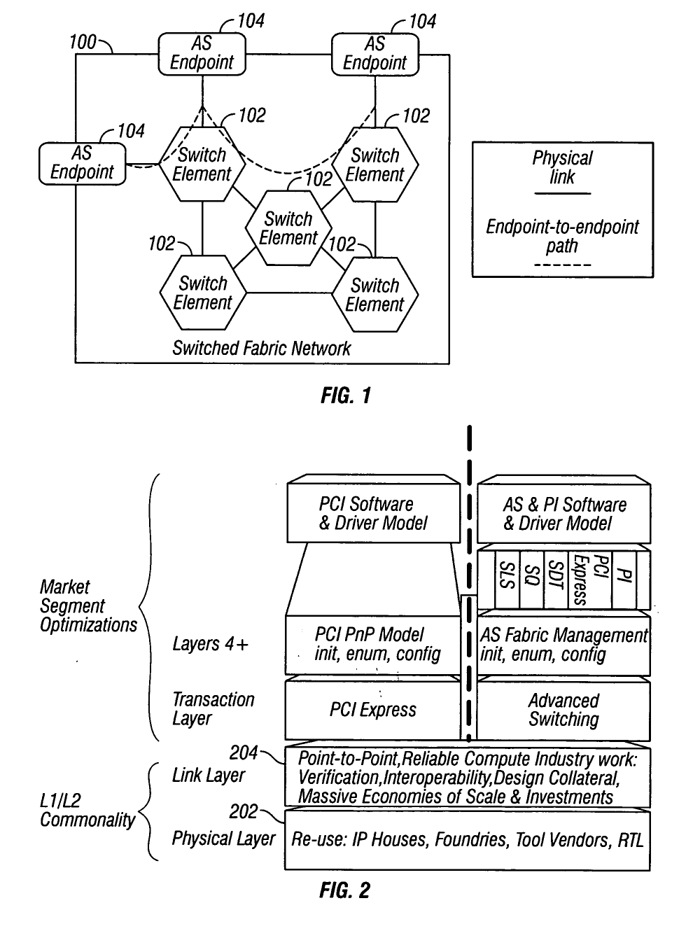

The network 100 may have an Advanced Switching (AS) architecture. AS utilizes a packet-based transaction layer protocol that operates over the PCI Express physical and data link layers 202, 204, as shown in FIG. 2.

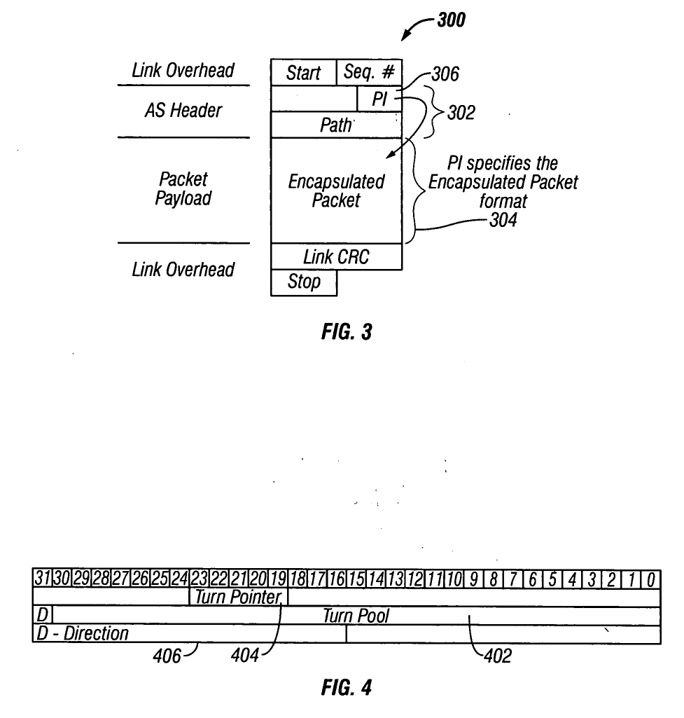

AS uses a path-defined routing methodology in which the source of a packet provides the information required by a switch (or switches) to route the packet to the desired destination. FIG. 3 shows an AS transaction layer packet (TLP) format 300. The packet includes a route header 302 and an encapsulated packet payload 304. The AS route header 302 contains the information necessary to route the packet through an AS fabric (i.e., “the path”), and a field that specifies the Protocol Interface (PI) of the encapsulated packet. AS switches may use only the information contained in the route header 302 to route packets independent of the contents of the encapsulated packet 304.

A path may be defined by the turn pool 402, turn pointer 404, and direction flag 406 in the route header, as shown in FIG. 4. A packet's turn pointer indicates the position of the switch's “turn value” within the turn pool. When a packet is received, the switch may extract the packet's turn value using the turn pointer, the direction flag, and the switch's turn value bit width. The extracted turn value for the switch may then used to calculate the egress port.

The PI field 306 in the AS route header 302 (FIG. 3) specifies the format of the encapsulated packet. The PI field may be inserted by the end node that originates the AS packet and may be used by the end node that terminates the packet to correctly interpret the packet contents. The separation of routing information from the remainder of the packet enables an AS fabric to tunnel packets of any protocol.

PIs represent fabric management and application-level interfaces to the switched fabric network 100. Table 1 provides a list of PIs currently supported by the AS Specification

TABLE 1
AS protocol encapsulation interfaces

| PI number | Protocol Encapsulation Identity (PEI) |
|---|---|
| 0 | Path Building |
| (0:0) | (Spanning Tree Generation) |
| (0:1-127) | (Multicast) |
| 1 | Congestion Management |
| 2 | Transport Services |
| 3 | Reserved |
| 4 | Device Management |
| 5 | Event Reporting |
| 6-7 | Reserved |
| 8-95 | ASI SIG ™ defined PIs |
| 96-126 | Vendor defined PIs |
| 127 | Invalid |

PIs 0-7 are reserved for various fabric management tasks, and PIs 8-126 are application-level interfaces. As shown in Table 1, PI8 is used to tunnel or encapsulate native PCI Express. Other PIs may be used to tunnel various other protocols, e.g., Ethernet, Fibre Channel, ATM (Asynchronous Transfer Mode), InfiniBand®, and SLS (Simple Load Store). An advantage of an AS switch fabric is that a mixture of protocols may be simultaneously tunneled through a single, universal switch fabric making it a powerful and desirable feature for next generation modular applications such as media gateways, broadband access routers, and blade servers.

The AS architecture supports the implementation of an AS Configuration Space in each AS device in the network. The AS Configuration Space is a storage area that includes fields to specify device characteristics as well as fields used to control the AS device. The information is presented in the form of capability structures and other storage structures, such as tables and a set of registers. The information stored in the capability structures may be accessed through PI-4 packets, which are used for device management.

A fabric manager election process may be initiated by a variety of either hardware or software mechanisms to elect one or more fabric managers for the switched fabric network. A fabric manager is an AS endpoint that “owns” all of the AS devices, including itself, in the network. If multiple fabric managers, e.g., a primary fabric manager and a secondary fabric manager, are elected, then each fabric manager may own a subset of the AS devices in the network. Alternatively, the secondary fabric manager may declare ownership of the AS devices in the network upon a failure of the primary fabric manager, e.g., resulting from a fabric redundancy and fail-over mechanism.

Once a fabric manager declares ownership, it has privileged access to it's AS devices' capability structures. In other words, the fabric manager has read and write access to the capability structures of all of the AS devices in the network, while the other AS devices may be restricted to read-only access, unless granted write permission by the fabric manager.

According to the PCI Express Link Layer definition a link between two AS devices is either down (DL_Inactive=no transmission or reception of packets of any type), fully active (DL_Active), i.e., fully operational and capable of transmitting and receiving packets of any type or in the process of being initialized (DL_Init).

AS architecture adds to PCI Express' definition of this state machine by introducing a new data-link layer state, DL_Protected, which becomes an intermediate state between the DL_Init and DL_Active states. The DL_Protected link state may be used to provide an intermediate degree of communication capability and serves to enhance an AS fabric's robustness and HA (High Availability) readiness.

The AS architecture supports the establishment of direct endpoint-to-endpoint logical paths known as Virtual Channels (VCs). This enables a single switched fabric network to service multiple, independent logical interconnects simultaneously, each VC interconnecting AS end nodes for control, management, and data. Each VC provides its own queue so that blocking in one VC does not cause blocking in another. Since each VC has independent packet ordering requirements, each VC may be scheduled without dependencies on the other VCs.

The AS architecture defines three VC types: bypass capable unicast (BVC); ordered-only unicast (OVC); and multicast (MVC). BVCs have two queues—an ordered-only queue and a bypass capable queue. The bypass capable queue provides BVCs bypass capability, which may be necessary for deadlock free tunneling of protocols. OVCs are single queue unicast VCs, which may be suitable for message oriented “push” traffic. MVCs are single queue VCs for multicast “push” traffic.

To preserve packet ordering, ordered-only packets and bypass capable packets may not pass previously enqueued ordered-only packets, and bypass capable packets may not pass previously enqueued bypass capable packets. To prevent the potential for deadlock, ordered-only packets may pass previously enqueued bypass capable packets that, due to lack of flow control credit, block their forward progress.

Bypass capable packets that have been bypassed by ordered-only packets, e.g., have been moved from the head of the ordered-only queue into the bypass capable queue, have by definition, already satisfied the BVC's ordering requirements. The following rule ensures that packets which have been previously bypassed are treated fairly, so that their flows are not exposed to potential starvation. All bypassed packets within the bypass capable queue must be the next packets moved out of the VC whenever there are sufficient bypass queue flow control credits to move them. This may continue until either there are insufficient bypass queue flow control credits to propagate other pending, previously bypassed packets or all bypassed packets have been propagated. Only after one of these condition becomes true can packets from the head of the ordered queue be propagated. This rule ensures that bypass capable packets that had already incurred their ordering delay area able to make forward progress as soon as possible.

When the fabric is powered up, link partners in the fabric may negotiate the largest common number of VCs of each VC type. During link training, the largest common sets of VCs of each VC type supported by both link partners may be initialized and activated.

During link training, surplus BVCs may be transformed into OVCs. A BVC can operate as an OVC by not utilizing its bypass capability, e.g., its bypass queue and associated logic. For example, if link partner A supports three BVCs and one OVC and the link partner B supports one BVC and two OVCs, the agreed upon number of VCs would one BVC and two OVCs, with one of link partner A's BVCs being transformed into an OVC.

AS packets may be assigned to one of eight possible traffic classes (TCs), e.g., TC0, TC1, . . . , TC7. The AS device ports may map a received packet to one of the port's active VCs of a given type (e.g., OVC, BVC, or MVC). One or multiple TC assignments may be mapped to the same VC depending on the number of VCs of the type that are active between link partners, and any given TC must be mapped to a single VC of the appropriate VC type within an AS port. TC-to-VC mapping is a function of the number of VCs that are active between link partners.

PI-5 Packet Generator

The AS architecture uses events as a notification mechanism. When a particular condition is detected in the fabric, an event may be sent to an agent responsible for handling that particular condition. Events may be arranged into event classes, and each event class may be identified using a class code. Depending on the event class, a class may further be divided into sub-classes.

AS devices may use PI-5 packets to report events. Endpoints must support the termination of PI-5 packets. If an endpoint receives a PI-5 packet, the endpoint need not be able to process the packet and may legally and silently discard any PI-5 packets the endpoint receives, e.g., if it is unable to process the packets or has been configured to discard them. According to the AS Specification, endpoints must support the generation of PI-5 packets, and switches must generate PI-5 packets.

An AS device may include an event dispatch unit to receive events and generate the PI-5 packets. PI-S packets may be directed to an event handler designated by a path stored at the AS device generating the event.

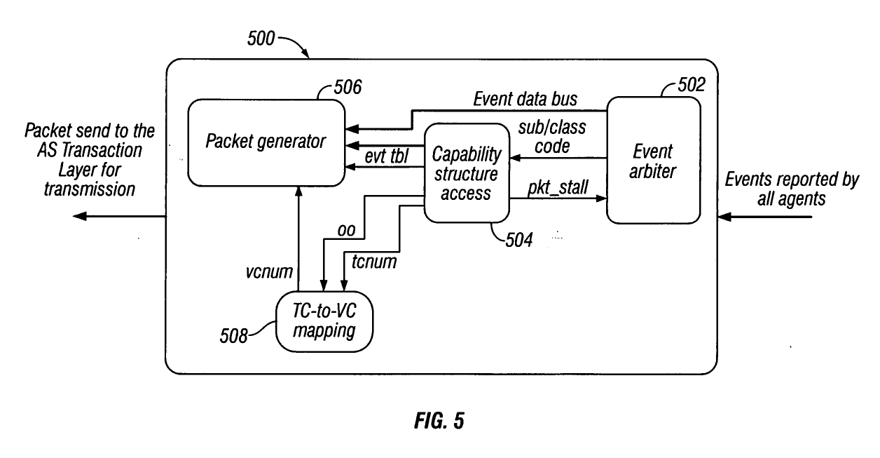

FIG. 5 shows an event dispatch unit 500 according to an embodiment. The event dispatch unit 500 may include an event arbiter 502, an event identifier, e.g., capability structure access block 504, a PI-5 packet generator 506, and a TC-to-VC mapping module 508.

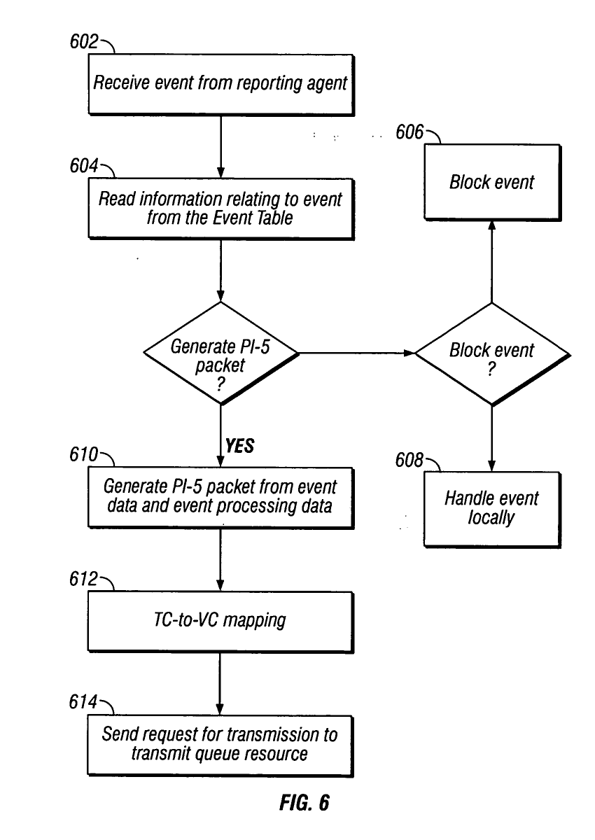

FIG. 6 is a flowchart describing an event dispatch operation according to an embodiment. The event arbiter 502 may interface with all of the event reporting agents in the AS device. The event arbiter may accept events, with their class/subclass codes, from the event reporting agents (block 602), e.g., one at a time in a round robin fashion. The event arbiter 502 may pass the event data to the packet generator 506 and event class/sub-class code to the capability structure access block 504.

The capability structure access block 504 may use the event class/subclass code to access the Event capability structure in the AS device. The Event capability structure may include an Event Table, which may include at least one entry for each class of events the AS is capable of generating.

The capability structure access block 504 may read information relating to the particular event from the entry in the Event Table corresponding to that event (block 604). The information in the Event Table entry for an event may indicate how the event should be handled. The capability structure access block 504 may decide between the following three options: block the event (block 606); handle the event locally (block 608); or generate a PI-5 packet to be transmitted to an agent over the AS fabric (block 610). Event entries indicating a PI-5 packet should be generated may include a destination for the packet and may also include information defining the event to the agent receiving the event. This information may be software generated and application specific.

If the capability structure access block 504 determines a PI-5 packet should be generated, the packet generator uses event data from the originating agent and event processing data from the capability structure access block to generate a PI-5 packet. PI-5 packets may contain a number of dwords (32-bit data words), e.g., two or six for short and long formats, respectively, in addition to the AS Route Header.

The TC-to-VC mapping module may map the generated PI-5 packet to a particular VC (block 612). The event dispatch unit may then send a request to the transmit queue resource in the AS transaction layer for transmission to the destination agent via the AS fabric (block 614).

Packet Arbitration for a VC

The event dispatch unit and other PI requesting agents may arbitrate for the transmit resources (e.g., transmit queue(s)) of a particular VC before the packets are sent out to the AS fabric. In an embodiment, a packet arbiter may provide low latency and fast data access for multiple PI requesting agents arbitrating for the transmit resources of a particular VC.

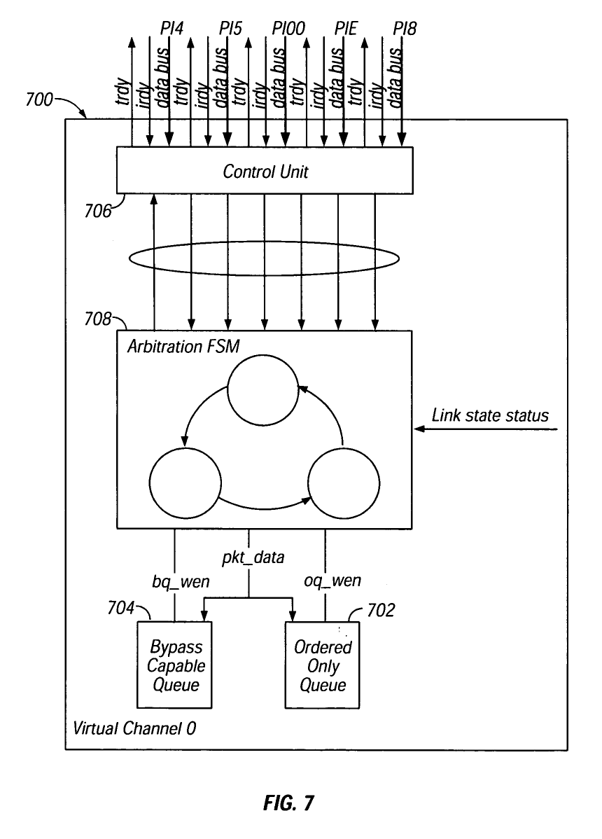

As shown in FIG. 7, a packet arbiter 700 may control access to the transmit resources of a particular VC, in this case BVC VCO. BVCs provide a special case of VC in that they include two transmit queues—an ordered-only queue 702, which only accepts ordered-only packets, and a bypass capable queue 704, which only accepts bypass capable packets. The packet arbiter 700 may access both transmit queues of the BVC. The arbiter receives outbound packet requests from PI requesting agents and passes the actual packet information from the PI requesting agents to the appropriate transmit queues.

The PI requesting agents may have a uniform interface with the arbiter 700, in this case, requesting agents for PI4, PI5, PI00, PIE (a generic engine for building PIs), and PI8. The arbiter interface may be expanded to incorporate additional vendor specific PIs or future ASI-SIG defined PIs.

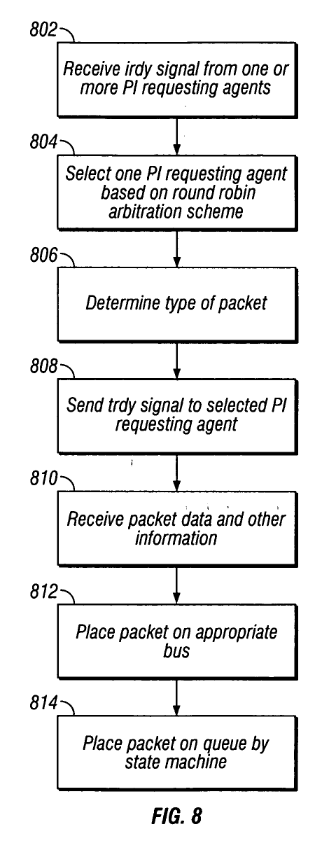

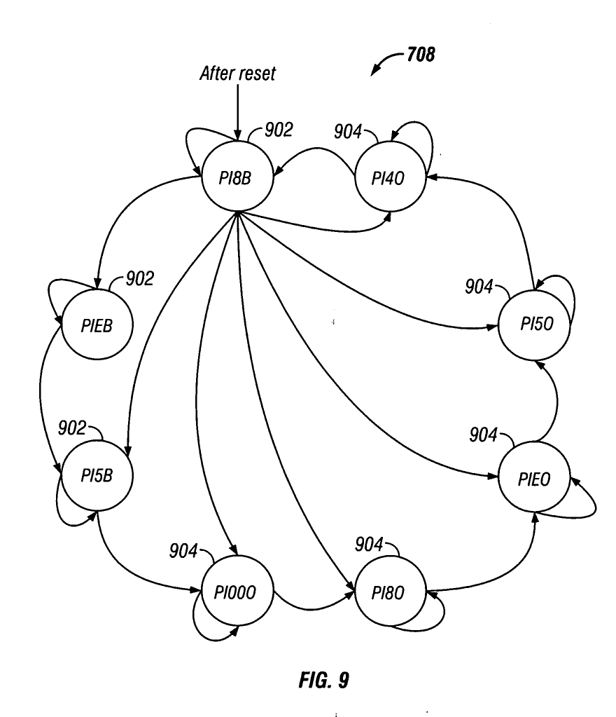

FIG. 8 is a flowchart describing a packet arbitration operation according to an embodiment. The bus protocol used between the arbiter 700 and the PI requesting agents may be a hand-shake protocol. When a packet becomes available from a requesting agent, that requesting agent may assert an initiator ready (irdy) signal. The control unit 706 may receive irdy signals from multiple requesting agents (block 802). When multiple irdy signals are received, the control unit may arbitrate between the requesting agents, e.g., using a round-robin arbitration scheme or any other arbitration method, such as priority or weighted. The round robin order may be based on the arrangement of the states in a state machine 708. The states may include bypass capable states 902 and ordered-only states 904, as shown in FIG. 9. The control unit 706 may follow the round robin order of the state machine 708 and move to the next available state based on the assertion of an irdy signal of a requesting agent. In the event there are no available packets, the state machine may remain in its current state in anticipation of the next packet. The state machine may be fully operational when the link state is DL_Active. However, when the link state is DL_Protected, only PI00O, PI4O, and PI5O states may be operational.

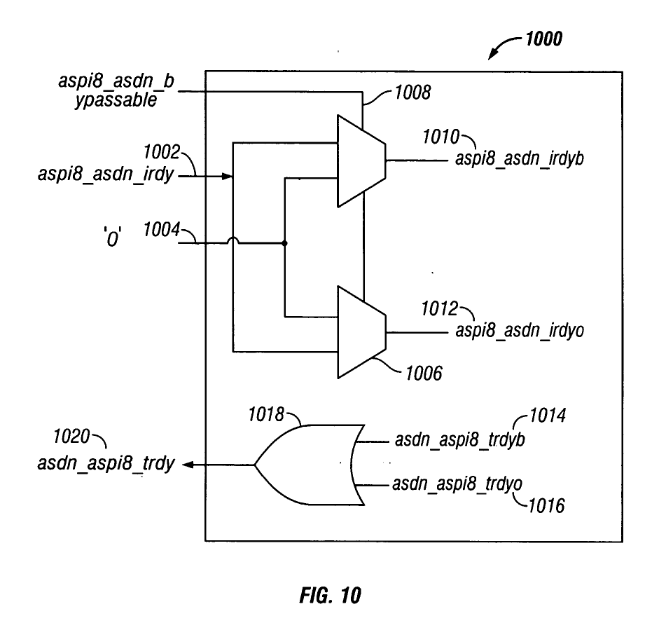

The control unit 706 may select a requesting agent based on the arbitration scheme (block 804) and the type of packet for the request (block 806). FIG. 10 shows exemplary circuit 1000 for identifying the packet type for the different PIs and separates them for different states. The data bus from each requester is shared among all states that the requester can access. However, each state will have its own set of hand-shake signals between the control unit and the requester. In this example, requester PI8 may send packets to two states, PI8O (ordered-only) and PI8B (bypass capable). The control unit may separate the source irdy signal 1002 by multiplexing the signal with a ‘0’ (LOW) signal 1004. The output of a multiplexer 1006 may be selected based on the type of the packet. For example, in the circuit shown in FIG. 10, if the aspi8_asdn_bypassable signal 1008 is asserted, the aspi8_asdn_irdyb signal 1010 will be connected to the source signal and the aspi8_asdn_irdyo signal 1012 will be ‘0’ and vice versa. Similarly, the two target ready (trdy) signals 1014, 1016 may be input to an OR gate 1018 together to produce a single trdy signal 1020 which may be asserted to the PI8 requesting agent.

When the arbiter 700 asserts the trdy signal back to the PI requesting agent (block 808), the PI requesting agent must start transferring the packet (block 810). The information collected by the packet arbiter may include the dword enables, start of packet indication, end of packet indication, and the packet data. The control unit place the packet information on the correct bus interface based on the identified packet type (block 812). The packet may then be placed in the appropriate queue by a queue controller (block 814), e.g., state machine 708.

FIG. 9 shows states and transitions in an exemplary state machine. For clarity, not all state transitions are shown. PI8B is arbitrarily chosen to demonstrate the complete set of transition arcs. The rest of the states may have similar transition arcs.

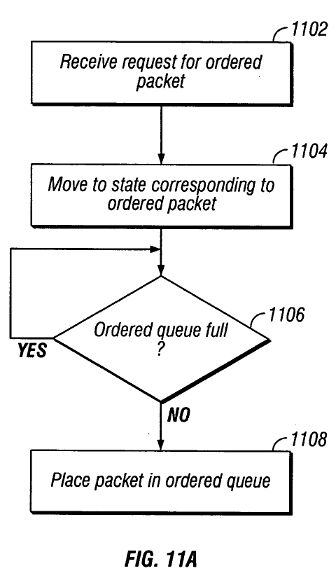

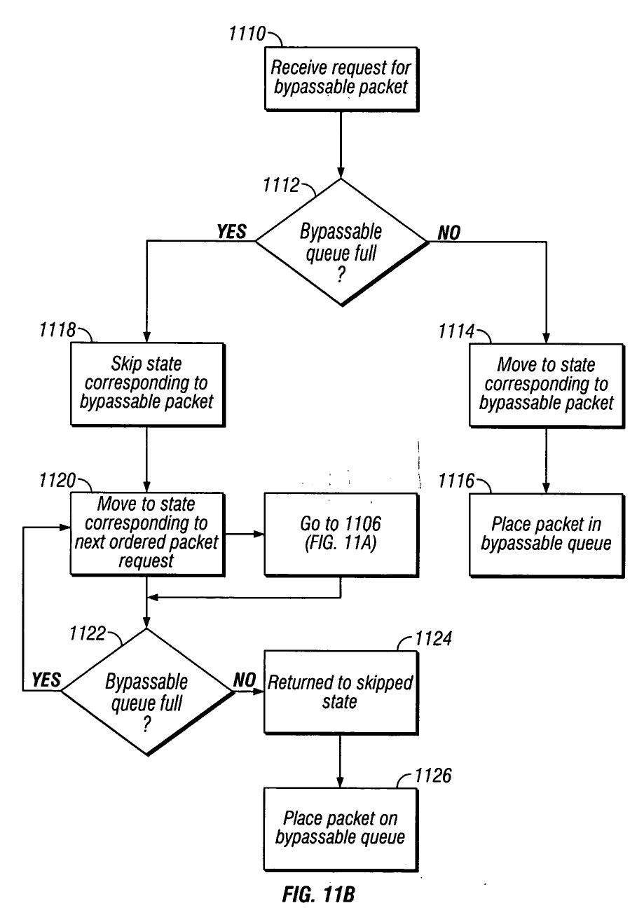

FIGS. 11A and 11B are flowcharts describing state transitions for requests for ordered-only packets and requests for bypass capable packets, respectively. As shown in FIG. 11A, when the arbiter receives a request for an ordered-only packet (block 1102), the state machine moves to the state corresponding to the ordered-only packet (block 1104). If the state machine determines that the transmit queue for ordered-only packets is full (block 1106), the state machine may wait in that state until the queue becomes available. Once the transmit queue becomes available, the arbiter places the packet in the ordered-only queue (block 1108).

As shown in FIG. 11B, when the arbiter receives a request for a bypass capable packet (block 1110), the state machine may determine whether the bypass capable queue is full (block 1112). If the bypass capable queue is available, the state machine moves to the state corresponding to the bypass capable packet (block 1114), and place the packet on the bypass capable queue (block 1116). If the transmit queue for bypass capable packets becomes full, the state machine may skip the state corresponding to the bypass capable packet (block 1118) and moves to the state corresponding to the next ordered-only packet (block 1120). The skipped state will be remembered. The state machine may process the ordered-only packet as described in FIG. 11A. Once the bypass capable queue becomes available again (block 1122), the state machine may finish its current transfer then move back to the previously skipped state (block 1124) and place the packet in the bypass capable queue (block 1126).

The packet arbitration scheme described above may also be implemented for OVCs and MVCs. In this case, only the ordered-only queue and ordered-only states are utilized.

Packet Arbitration for Multiple VCs

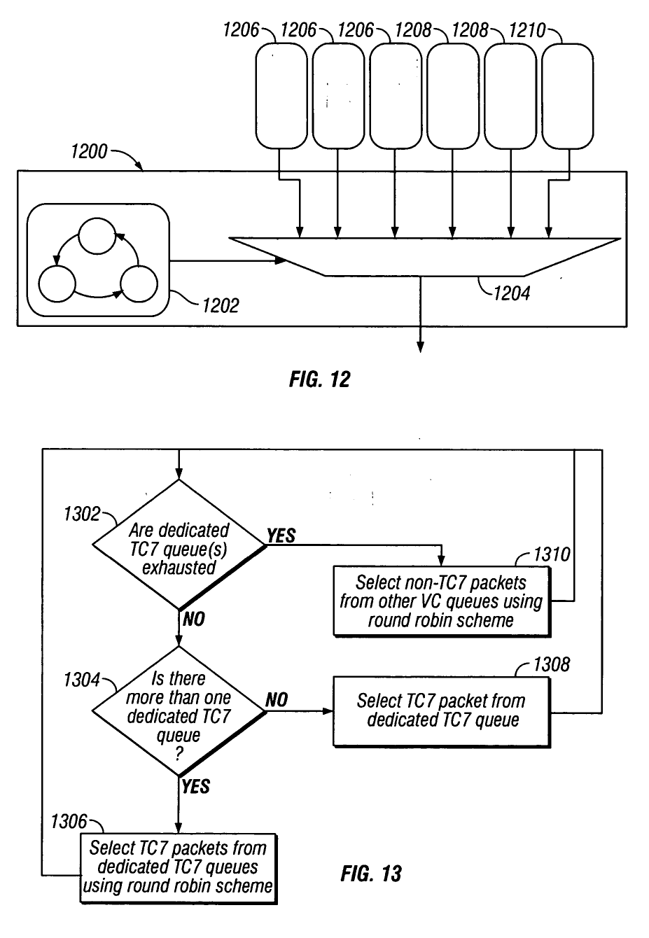

As shown in FIG. 12, a packet arbiter 1200 downstream from the VC queues in the AS transaction layer may arbitrate between packets to be sent into the AS fabric. In an embodiment, the packet arbiter 1200 may include a state machine 1202 and a multiplexer 1204 that interfaces with the transmit queues of the active VCs, which may include BVC(s) 1206, OVC(s) 1208, and/or MVC(s) 1210. Each clock cycle, the packet arbiter 1200 may select the head packet from one of the transmit queues and send the selected packet into the AS fabric.

The packet arbiter 1200 may perform certain duties of a fabric manager by regulating packet traffic in order to allow high priority (TC7) packets to be transmitted first. Since TC7 packets can pass through any type of VC, the packet arbiter may also handle a second level of arbitration between multiple TC7 packets. These decisions may be made within one clock cycle, thereby reducing latency in the transmit path.

In the AS architecture, the TC7 traffic class is reserved for high priority traffic. TC7 packets may be mapped exclusively to a dedicated VC corresponding to the highest numbered active VC of the specified VC type. The packet arbiter may dynamically identify the VC number which corresponds to TC7 for each VC type. Since each BVC is capable of being converted into an OVC, this feature may allow the packet arbiter to handle variable BVC and OVC combinations without using additional hardware, further reducing latency.

FIG. 13 is a flowchart describing a packet arbitration operation according to an embodiment. The state machine 1202 determines if the dedicated TC7 queue(s) are empty (block 1302), where a dedicated TC7 transmit queue refers to a queue that only holds TC7 packets. The state machine may have a number of states corresponding to the number of active VCs, and when in a state, may select a packet from a VC queue corresponding to that state. The state machine may remain in a state corresponding to a dedicated TC7 queue as long as the TC7 queue is not empty (for dedicated TC7 BVCs, the state machine must stay in the state until the TC7 queue is empty). If there are multiple dedicated TC7 queues from different VCs (block 1304), the state machine may transition between states corresponding to the dedicated TC7 queues using a round robin arbitration scheme (block 1306). Otherwise, the state machine may exhaust all packets from the sole dedicated TC7 queue (block 1308) before moving to a state corresponding to a non-TC7 dedicated VC queue. When all packets in the TC7 dedicated queues are exhausted, the state machine may transition between the states corresponding to the queues of the non-TC7 dedicated VCs using a round robin arbitration scheme (block 1310).

A number of embodiments have been described. Nevertheless, it will be understood that various modifications may be made without departing from the spirit and scope of the invention. For example, blocks in the flowchart may be skipped or performed out of order and still produce desirable results. Accordingly, other embodiments are within the scope of the following claims.

1. An apparatus comprising:
an event arbiter to select an event from at least one reported event;
an event identifier to identify information relating to the event and determine whether to generate an event reporting packet; and
a packet generator to generate the event reporting packet corresponding to the event; and
a mapping module to map the event reporting packet to a virtual channel on which to send the packet.

2. The apparatus of claim 1, wherein the event arbiter is operative to receive events from one or more event reporting agents in an Advanced Switching device.

3. The apparatus of claim 2, wherein the event identifier is operative to access an entry corresponding to the event in an event table in a capability structure of the Advanced Switching device.

4. The apparatus of claim 1, wherein the event identifier is operative to identify the event based on a class and subclass of the event.

5. The apparatus of claim 1, wherein the event reporting packet comprises a protocol interface (PI)-5 packet.

6. The apparatus of claim 1, wherein the event identifier is operative to determine
whether to block the event,
whether to handle the event locally, or
whether to generate the event reporting packet for transmission on the switched fabric.

7. A method comprising:
receiving one or more events from one or more event reporting agents;
selecting one of the events;
identifying information relating to the event;
determining whether to generate an event reporting packet corresponding to the event;
generating the event reporting packet, the event reporting packet having a traffic class; and
mapping the traffic class of the event reporting packet to a virtual channel on which to send the packet.

8. The method of claim 7, wherein said receiving the one or more events comprises receiving one or more events from one or more event reporting agents in an Advanced Switching device.

9. The method of claim 8, wherein said identifying information relating to the event comprises accessing an entry corresponding to the event in an event table in a capability structure of the Advanced Switching device.

10. An article comprising a machine-readable medium including machine-executable instructions to cause a machine to:
receive one or more events from one or more event reporting agents;
select one of the events;
identify information relating to the event;
determine whether to generate an event reporting packet corresponding to the event;
generate the event reporting packet, the event reporting packet having a traffic class; and
map the traffic class of the event reporting packet to a virtual channel on which to send the packet.

11. The article of claim 10, wherein the instructions to cause the machine to receive the one or more events comprise instructions to cause the machine to receive one or more events from one or more event reporting agents in an Advanced Switching device.

12. The article of claim 11, wherein the instructions to cause the machine to identify information relating to the event comprise instructions to cause the machine to accessing an entry corresponding to the event in an event table in a capability structure of the Advanced Switching device.

13. A system comprising:
a switched fabric; and
a node coupled to the switched fabric, the node including:
an event arbiter to select an event from one or more reported events;
an event identifier to identify information relating to the event and determine whether to generate an event reporting packet;
a packet generator to generate the event reporting packet corresponding to the event, the event reporting packet having a traffic class; and
a mapping module to map the traffic class of the event reporting packet to a virtual channel on which to send the packet.

14. The system of claim 13, wherein the switched fabric comprises an Advanced Switching network.

15. An apparatus comprising:
a first queue corresponding to a virtual channel;
a second queue corresponding to the virtual channel;
a control unit to
select a packet from one or more available packets, and
determine if the packet is of a first type or a second type; and
a queue controller to
receive the packet from the control unit,
store the packet in the first queue if the packet is of the first type and the first queue is not full, and in response to the first queue being full, wait until the first queue is not full, and
store the packet in the second queue if the packet is of the second type and the second queue is not full, and in response to the second queue being full, wait for a packet of the first type.

16. The apparatus of claim 15, wherein the queue controller is operative to:
in response to the packet being of the second type and the second queue being full, receive a packet of the first type;
store the packet of the first type in the first queue if the first queue is not full, and in response to the first queue being full, wait until the first queue is not full; and
after storing the packet of the first type in the first queue, store the packet of the second type in the second queue if the second queue is not full, and in response to the second queue being full, wait for another packet of the first type.

17. The apparatus of claim 15, wherein the queue controller comprises a state machine including one or more states corresponding to packets of the first type and one or more states corresponding to packets of the second type.

18. The apparatus of claim 15, wherein the apparatus comprises an Advance Switching device.

19. The apparatus of claim 18, wherein the virtual channel comprises a bypass capable virtual channel,
wherein the first type of packet comprises an ordered-only packet, and
wherein the second type of packet comprises a bypass capable packet.

20. A method comprising:
selecting a packet from one or more available packets for a virtual channel;
determining if the packet is of a first type or a second type;
storing the packet in a first queue if the packet is of the first type and the first queue is not full, and in response to the first queue being full, waiting until the first queue is not full; and
storing the packet in a second queue if the packet is of the second type and the second queue is not full, and in response to the second queue being full, waiting for a packet of the first type.

21. The method of claim 20, wherein said storing the packet in the second queue further comprises:
receiving the packet of the first type;
storing the packet of the first type in the first queue if the first queue is not full, and in response to the first queue being full, waiting until the first queue is not full; and
after storing the packet of the first type in the first queue, storing the packet of the second type in the second queue if the second queue is not full, and in response to the second queue being full, waiting for another packet of the first type.

22. The method of claim 20, wherein said selecting a packet comprises selecting a packet for a bypass capable virtual channel in an Advance Switching network.

23. The method of claim 20, wherein said determining comprises determining whether the packet is an ordered-only packet or a bypass capable packet.

24. An article comprising a machine-medium including machine-executable instructions to cause a machine to:
select a packet from one or more available packets for a virtual channel;
determine if the packet is of a first type or a second type;
store the packet in a first queue if the packet is of the first type and the first queue is not full, and in response to the first queue being full, waiting until the first queue is not full; and
store the packet in a second queue if the packet is of the second type and the second queue is not full, and in response to the second queue being full, waiting for a packet of the first type.

25. The article of claim 24, wherein the virtual channel comprises a bypass capable virtual channel in an Advance Switching network.

26. A system comprising:
a switched fabric; and
a node coupled to the switched fabric, the node including:
a first queue corresponding to a virtual channel;
a second queue corresponding to the virtual channel;
a control unit to
select a packet from one or more available packets, and
determine if the packet is of a first type or a second type; and
a queue controller to
receive the packet from the control unit,
store the packet in the first queue if the packet is of the first type and the first queue is not full, and in response to the first queue being full, wait until the first queue is not full, and
store the packet in the second queue if the packet is of the second type and the second queue is not full, and in response to the second queue being full, wait for a packet of the first type.

27. The system of claim 26, wherein the virtual channel comprises a bypass capable virtual channel in an Advanced Switching system,
wherein the first type of packet comprises an ordered-only packet, and
wherein the second type of packet comprises a bypass capable packet.

28. An apparatus comprising:
an interface to receive a plurality of packets from a plurality of packet queues, each packet queue corresponding to one virtual channel; and
a packet arbiter to determine if the plurality of packets include one or more high priority packets, and to select from the high priority packets until said high priority packets are exhausted.

29. The apparatus of claim 28, wherein the plurality of packet queues comprise one or more dedicated high priority packet queues including only high priority packets.

30. The apparatus of claim 29, wherein the arbiter is operative to
determine if the plurality of packet queues include a plurality of high priority packet queues, and
select from the plurality of high priority packet queues using a round robin scheme until the high priority packets are exhausted.

31. The apparatus of claim 28, wherein the interface comprises a multiplexer and the packet arbiter includes a state machine including a state for each packet queue.

32. The apparatus of claim 28, wherein the apparatus comprises an Advanced Switching device.

33. The apparatus of claim 32, wherein the high priority packets comprise TC7 packets.

34. A method comprising:
receiving a plurality of packets from a plurality of packet queues, each packet queue corresponding to one virtual channel;
determining if the plurality of packets include one or more high priority packets; and
selecting from the high priority packets until said high priority packets are exhausted.

35. The method of claim 34, further comprising:
determining if the plurality of packet queues include a plurality of high priority packet queues; and
in response to the plurality of packet queues including a plurality of high priority packet queues, selecting from the plurality of high priority packet queues using a round robin scheme until the high priority packets are exhausted.

36. The method of claim 34, wherein said receiving the plurality of packets comprises receiving a plurality of packets from a plurality of packet queues in an Advanced Switching device.

37. The method of claim 36, wherein said determining comprises determining if the plurality of packets include one or more TC7 packets.

38. An article comprising a machine-readable medium including machine-executable instructions to cause a machine to:
receive a plurality of packets from a plurality of packet queues, each packet queue corresponding to one virtual channel;
determine if the plurality of packets include one or more high priority packets; and
select from the high priority packets until said high priority packets are exhausted.

39. The article of claim 38, wherein high priority packets comprise TC7 packets.

40. A system comprising:
a switched fabric; and
a node coupled to the switched fabric, the node including:
an interface to receive a plurality of packets from a plurality of packet queues, each packet queue corresponding to one virtual channel; and
a packet arbiter to determine if the plurality of packets include one or more high priority packets, and to select from the high priority packets until said high priority packets are exhausted.

41. The system of claim 40, wherein the switched fabric comprises an Advanced Switching network, and wherein the high priority packets comprise TC7 packets.
